(19) United States
(12) Patent Application Publication
(10) Pub. No.: US 2010/0329146 A1
(43) Pub. Date: Dec. 30, 2010

(54) FLOW INFORMATION COLLECTION APPARATUS

(75) Inventors: Katsunori Yoshida, Kawasaki (JP); Takaaki Kawakami, Kawasaki (JP); Shigemi Hashimoto, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/874,358

(22) Filed: Sep. 2, 2010

Related U.S. Application Data
(63) Continuation of application No. PCT/JP2008/055544, filed on Mar. 25, 2008.

(51) Int. Cl. H04J 3/14

(52) U.S. Cl. 370/253

(57) ABSTRACT

In a flow information collection apparatus, flow information, which is sampled based on a predetermined sampling value, is periodically collected and accumulated from a router being a subject. A group of distributions of values is specified for each measurement subject from data in which the values for the each measurement subject in the flow information accumulated are distributed in a time period in a plurality of past days. A representative group is specified from the specified group and an average is acquired. The sampling value for next time is determined from the average of the representative group.

### CROSS-REFERENCE TO RELATED APPLICATION

This application is a U.S. continuation application filed under 35 USC 111(a) claiming benefit under 35 USC 120 and 365(c) of PCT application JP2008/055544, filed on Mar. 25, 2008. The foregoing application is hereby incorporated herein by reference.

### FIELD

The present invention generally relates to a flow information collection apparatus for collecting flow information indicating a traffic state from routers in a network.

### BACKGROUND

FIG. 1A is a diagram illustrating a configuration example for collecting flow information in a MPLS-VPN (Multi Protocol Label Switching-Virtual Private Network). In FIG. 1A, each of core routers CR1 through CR4 includes a function for outputting flow statistical information (flow information) of a label unit of the MPLS. A flow information collection apparatus (NetFlow Collector) 1 periodically collects the flow information from the core routers CR1 through CR4. Accordingly, it is possible to collect a traffic amount of packets passing a physical line (MPLS packet relay line) connecting between the routers for each service such as a virtual network (VPN) or the like. Conventionally, the traffic amount has been collected by a port unit in edge routers (ER1 through ER6), and it has not been possible to comprehend a VPN traffic tendency and the traffic amount at each edge router in the network. However, by using a flow information output function of the core routers CR1 through CR4, it becomes possible to realize traffic measurement between edge routers for each VPN.

FIG. 1B is a diagram illustrating traffic between the core router CR1 and the core router CR2 in the network depicted in FIG. 1A. In FIG. 1B, traffic flowing from the edge router ER1 to the edge router ER5 and traffic flowing from the edge router ER4 to the edge router ER1 are included in a virtual network VPN-A. Also, traffic flowing from the edge router ER2 to the edge router ER3 are included in a virtual network VPN-B.

FIG. 2 is a schematic diagram illustrating flow information collection based on a method called a Sampled Net Flow method which captures one packet from s packets in packets passing the MPLS packet relay line. If all packets are captured in an interface of a high speed line, a CPU workload and an amount of memory consumption are increased and influence processing of a router.

In FIG. 2, when the flow information collection apparatus 1 sends an Export request to the core router CR1 (to other core routers in the same manner) at a collection period (for example, hourly) (step ST1), the core router CR1 clears statistical information in response to the Export request (step ST2). The core router CR1 captures one packet from s packets (sampling value) in packets passing the MPLS packet relay line via an own interface (step ST3). The sampling value “s” is an arbitrary value which can be set as input information. In accordance with a predetermined error rate calculation method, the sampling value “s” is obtained so as to be within a range of a predetermined error rate. The sampling value “s” is set formally as a fixed system value. The following expression is used as the error rate calculation method:

Error rate (%)≈196×√(1/C)
C: packet number (sample number).
   The packet number “C” is obtained so that the error rate is within a predetermined value (for example, 5%), and the sampling value “S” is obtained to acquire the packet number “C”.

Subsequently, the core router CR1 identifies a flow from a label applied to the captured packet, obtains an aggregation of the traffic amount for each label, and generates the flow information by performing a statistic process (step ST4). The flow information is stored in a net flow cache in a memory, and is used as flow statistic information.

Then, the core router CR1 sends the flow information to the flow information collection apparatus 1 by a UDP (User Datagram Protocol) or the like (step ST5). The flow information collection apparatus 1 accumulates the flow information received from the core router CR1 (step ST6).

The flow information collected in the above-mentioned manner is utilized for expansion and reduction of network devices and the like.

However, in order to improve the error rate and accuracy of the flow information, there is a problem in the above-mentioned method in which the sampling value “s” is the fixed system value.

First, in the Sampled Net Flow method, an error occurs in the statistic information in the above-described expression. In the expression, in order to simply reduce the error rate, the sample number “C” is increased. In order to increase the sample number “C”, it is required to make an aggregation time be longer. Otherwise, it is required to increase a sample rate by reducing a sampling value “s” of the router.

However, in traffic measurement in an operational system including the function, it is not possible to easily extend the aggregation time, since the collection period is defined by a fixed interval. In addition, if the sample rate is increased at the router, workload is increased and a routing process of the router is interfered with by the increased workload.

In detail, in a case in which the traffic amount (number of packets and etc.) passing the router is relatively high, the sampling value “s” is set to be large. In this case, if the collection period is set as the fixed interval not to influence the workload of the router in a system operation, there may not be a problem according to a calculation result of the error rate.

However, in a case in which the traffic amount is relatively low or the workload is not heavy (is moderate), if the sampling value “s” is set to be large, many cases occur in which the traffic amount of packets passing the router cannot be accurately captured. In this case, the sampling value “s” is required to be smaller and to be sampled at a shorter period.

On the other hand, even if by utilizing an existing error rate calculation, the traffic amount is adequately obtained with a proper sampling value “s” in an initial setting condition (for example, at a time of starting an operation), since the workload of the network is constantly fluctuating from day to day, depending on conditions of a use state of a network user, a region, time, a use type of the router (the core router, the edge router, or the like) and the like, the workload and the amount of resources in the network are varied and a flow control process can be delayed.

Moreover, since each of the routers may have a different product specification and operates depending on a version of internal software and setting contents of a configuration (Config), a use resource amount indicates a different amount depending on a situation as well as workload information of a CPU. Thus, in an actual operation, in a case in which the sampling value “s” is the fixed system value, the packets may not be captured and measured at a proper sampling value.

Accordingly, in a case of simply applying a fixed sampling value defined beforehand by a method using various calculation logic schemes, other conditions, and the like, since the traffic amount of packages constantly passing the routers is varied depending on operations and the workload condition of the network, a problem occurs in that the flow information cannot be properly collected.

In the above, a collection of the flow information in the MPLS-VPN is described as an example. The above-described problems can be generally raised in the flow information collection apparatus in which the flow information is acquired in each of the routers and the flow information is collected from each of the routers.

On the other hand, Japanese Laid-open Patent Application No. 2003-244195 discloses a technology for extracting a peak traffic amount which indicates a higher value than other traffic amounts acquired at the times before and after the peak traffic amount is acquired, in chronological data of communication traffic. Japanese Laid-open Patent Application No. 7-15512 discloses a technology for totaling information sampled at every call, editing as traffic data, and correcting subsequent information being sampled by the traffic data. However, technologies disclosed in the above Japanese Laid-open Patent Applications do not overcome the above-described problems.

### SUMMARY

According to an aspect of the embodiment, a flow information collection apparatus includes a flow information accumulation part configured to periodically collect and accumulate flow information which is sampled based on a predetermined sampling value, from a router being a subject; a distribution result calculation process part configured to specify a group of distributions of values for each measurement subject, from data in which the values for the each measurement subject in the flow information accumulated by the flow information accumulation part are distributed in a time period in a plurality of past days; a distribution information determination process part configured to specify a representative group from the group specified by the distribution result calculation process part and to acquire an average; and a correction information determination process part configured to determine the sampling value after a next time from the average of the representative group specified by the distribution information determination process part.

The object and advantages of the embodiment will be realized and attained by means of the elements and combinations particularly pointed out in the claims.

It is to be understood that both the foregoing general description and the following detailed description are exemplary and explanatory and are not restrictive of the embodiment as claimed.

### BRIEF DESCRIPTION OF THE DRAWINGS

FIG. 1A is a diagram illustrating a configuration example for collecting flow information in a MPLS-VPN;

FIG. 1B is a diagram illustrating traffic between core routers in the network depicted in FIG. 1A;

FIG. 2 is a schematic diagram illustrating a flow information collection;

FIG. 3 is a diagram illustrating a configuration example of a flow information collection apparatus according to an embodiment;

FIG. 4A is a diagram illustrating a data structure of accumulated data of traffic measurement results;

FIG. 4B is a diagram illustrating a data structure of process counter data for traffic measurement;

FIG. 4C is a diagram illustrating a data structure of basic calculation data of the traffic measurement results;

FIG. 5A is a diagram illustrating a data structure of MIB data;

FIG. 5B is a diagram illustrating a data structure of survey data of traffic distribution;

FIG. 5C is a diagram illustrating a data structure of calculation result data of the traffic distribution;

FIG. 6A is a diagram illustrating a data structure of accumulated data of the collection information;

FIG. 6B is a diagram illustrating a data structure of system schedule information;

FIG. 7 is a flowchart for explaining a process example of a correction control process part;

FIG. 8 is a flowchart for explaining a process example of an accumulated information edit process part;

FIG. 9 is a flowchart (part 1) for explaining a process example of an accumulated information control process part;

FIG. 10 is a flowchart (part 2) for explaining the process example of the accumulated information control process part;

FIG. 11 is a flowchart (part 3) for explaining the process example of the accumulated information control process part;

FIG. 12 is a flowchart for explaining a process example of an accumulated information calculation process part;

FIG. 13 is a flowchart for explaining a process example of a distribution result calculation process part;

FIG. 14 is a diagram illustrating a brief overview of a distribution result calculation process;

FIG. 15 is a flowchart for explaining a process example of a distribution information determination process part;

FIG. 16 is a flowchart for explaining a process example of a correction information determination process part;

FIG. 17 is a flowchart (part 1) for explaining a process example of a measurement information conformity process part;

FIG. 18 is a flowchart (part 2) for explaining the process example of the measurement information conformity process part;

FIG. 19 is a flowchart for explaining a process example of a special analysis process part;

FIG. 20 is a flowchart for explaining a process example of a special diagnosis process part; and

FIG. 21 is a diagram illustrating an advantage example by a collection of the flow information.

### DESCRIPTION OF EMBODIMENT

In the following, an embodiment of the present invention will be described with reference to the accompanying drawings.

### <System Configuration>

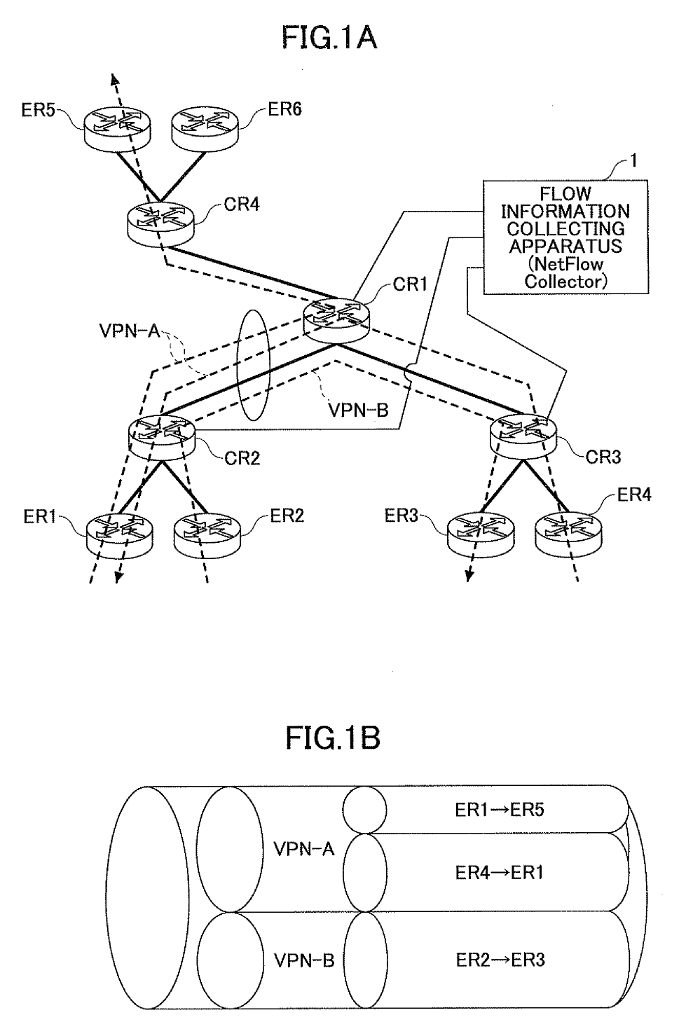

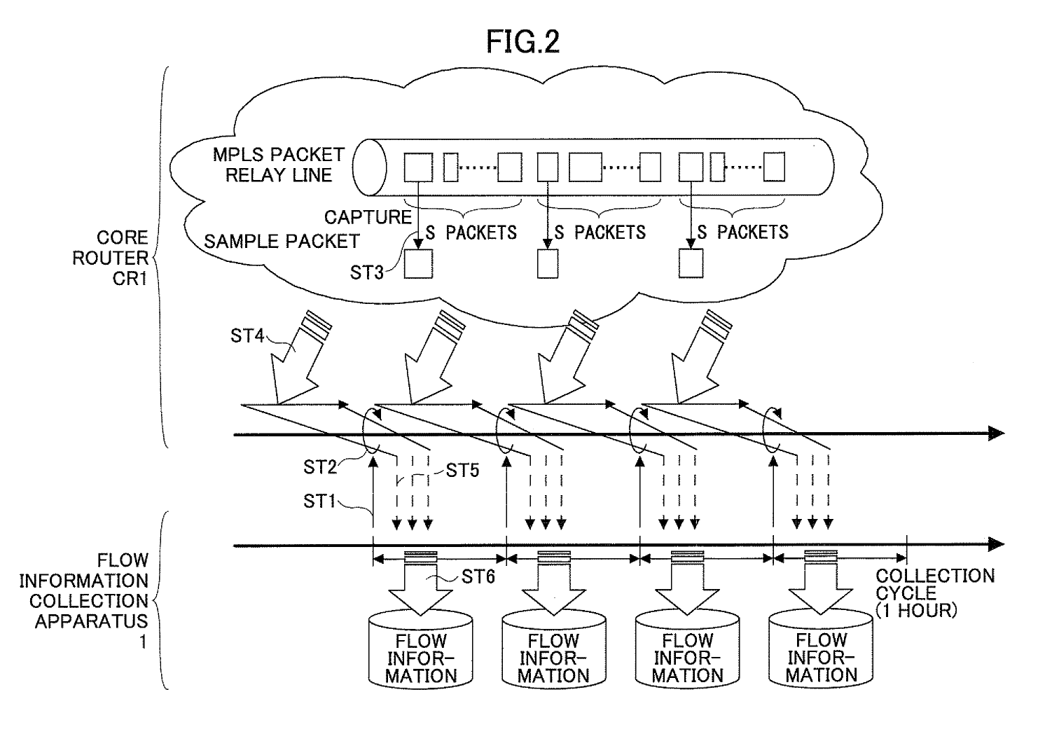

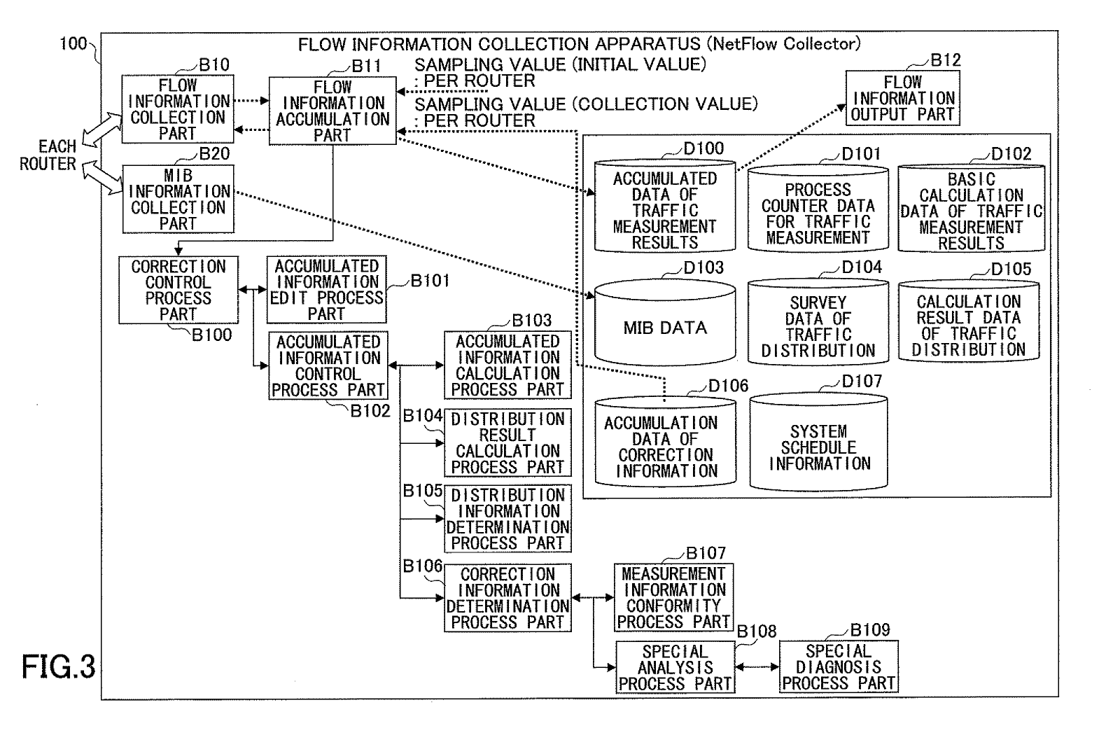

FIG. 3 is a diagram illustrating a configuration example of a flow information collection apparatus according to an embodiment. A network configuration in the embodiment is the same as that illustrated in FIG. 1A, and the flow information collection apparatus 1 in FIG. 1A is replaced with a flow information collection apparatus 100 including new functions.

In FIG. 3, the flow information collection apparatus 100 includes a flow information collection part B10, a flow information accumulation part B11, a flow information output part B12, an MIB information collection part B20, a correction control process part B100, an accumulated information edit process part B101, an accumulated information control process part B102, an accumulated information calculation process part B103, a distribution result calculation process part B104, a distribution information determination process part B105, a correction information determination process part B106, a measurement information conformity process part B107, a special analysis process part B108, and a special diagnosis process part B109. These process parts B10, B11, B20, and B101 through B109 are realized by computer programs executed by using hardware resources such as a CPU (Central Processing Unit), a ROM (Read Only Memory), a RAM (Random Access Memory), and the like of a computer functioning as the flow information collection apparatus 100.

Also, the flow information collection apparatus 100 retains accumulated data D100 of traffic measurement results, process counter data D101 for traffic measurement, basic calculation data D102 of the traffic measurement results, MIB data D103, survey data D104 of traffic distribution, calculation result data D105 of the traffic distribution, accumulation data D106 of correction information, and system schedule information D107, as data for various processes.

The flow information collection part B10 includes a process for periodically collecting the flow information from routers (core routers CR1 through CR3, and the like in FIG. 1A) each of which includes a process for outputting the flow information of a label unit of the MPLS. As a sampling value at each of the routers, the flow information collection part B10 indicates a value (an initial value at a collection start and a correction value after correction control starts), which is indicated by the flow information accumulation part B11, for each of the routers.

The flow information accumulation part B11 includes a process for accumulating the flow information collected from each of the routers through the flow information collection part B10, in the accumulated data D100 of the traffic measurement results.

The flow information output part B12 includes a process for outputting the flow information accumulated in the accumulated data D100 of the traffic measurement results for an operator in order to utilize the flow information for expansion and reduction of network devices and the like.

The MIB information collection part B20 includes a process for collecting MIB (Management Information Base) information including a CPU use rate from each of the routers, and accumulating the MIB information in the MIB data D103.

The correction control process part B100 is activated via the flow information accumulation part B11 after collecting the flow information by applying the sampling value of the initial value at the flow information accumulation part B11 in a certain period, and includes a control process as a whole to correct the sampling value used at each of the routers to acquire the flow information.

The accumulated information edit process part B101 is activated by the correction control process part B100, and includes a process for extracting necessary information from the flow information accumulated in the accumulated data D100 of the traffic measurement results and accumulating basic data used in later processes in the basic calculation data D102 of the traffic measurement results.

The accumulated information control process part B102 is activated by the correction control process part B100, and includes a further detailed control process to correct the sampling values used at each of the routers to acquire the flow information.

The accumulated information calculation process part B103 is activated by the accumulated information control process part B102, and includes a process for calculating an error rate of basic traffic information, calculating the CPU use rate at the routers from the MIB information accumulated in MIB data D103, and accumulating a result in the basic calculation data D102 of the traffic measurement results.

The distribution result calculation process part B104 is activated by the accumulated information control process part B102, and includes a process for specifying a group of distribution of values which are measurement subjects in the basic calculation data D102 of the traffic measurement results, and accumulating a result in the calculation result data D105 of the traffic distribution. In this case, the survey data D104 of traffic distribution are used as input information defining a survey range.

The distribution information determination process part B105 is activated by the accumulated information control process part B102, and includes a process for specifying a representative group from groups of distribution results accumulated in the calculation result data D105 of the traffic distribution, acquiring an average of the groups of the distribution result, and accumulating a result in the calculation result data D105 of the traffic distribution.

The correction information determination process part B106 is activated by the accumulated information control process part B102, and includes a process for determining the correction value of the sampling value based on the results accumulated in the calculation result data D105 of the traffic distribution and accumulating a result in the accumulation data D106 of the correction information.

The measurement information conformity process part B107 is activated by the correction information determination process part B106, and includes a process for determining whether or not a correction of the sampling value is valid in terms of the CPU use rate, the packet number, and a measurement delay time with respect to the result accumulated in the accumulation data D106 of the correction information, and conforming the sampling value to be a further adequate value.

The special analysis process part B108 is activated by the correction information determination process part B106, and includes a process for adjusting the sampling value based on an outstanding value which is determined by the measurement information conformity process part B107 as a value which is not conformed with respect to the results accumulated in the accumulation data D106 of the correction information and is excluded from the group of the distribution results

The special diagnosis process part B109 is activated by the special analysis process part B108, and includes a process for determining validity of the outstanding value excluded from the group of the distribution results based on the system schedule information D107 with respect to the results accumulated in the accumulation data D106 of the correction information, and adjusting the sampling value.

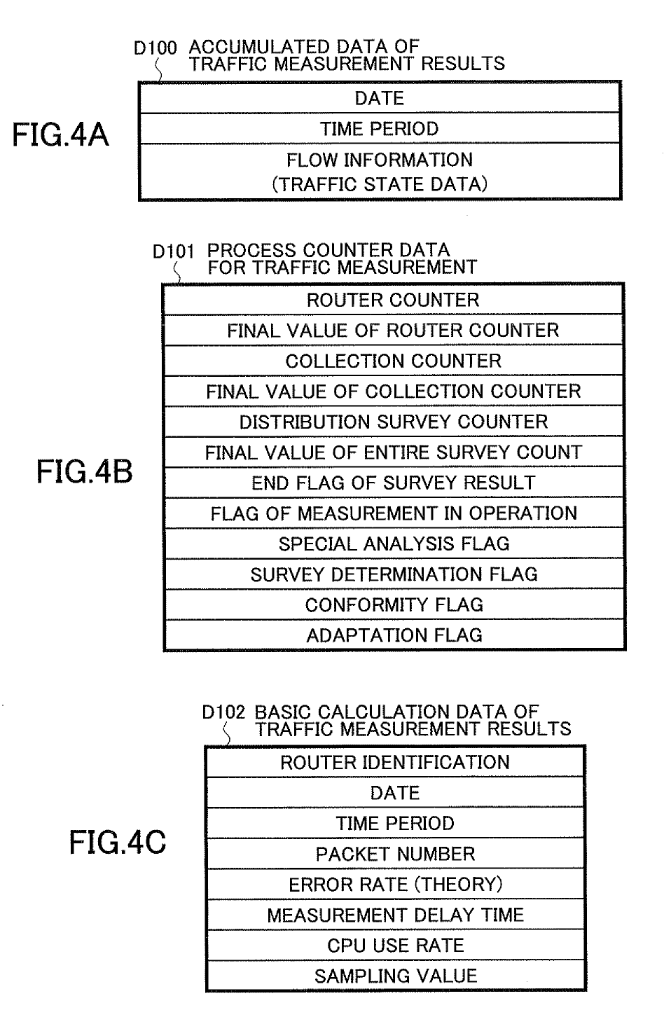

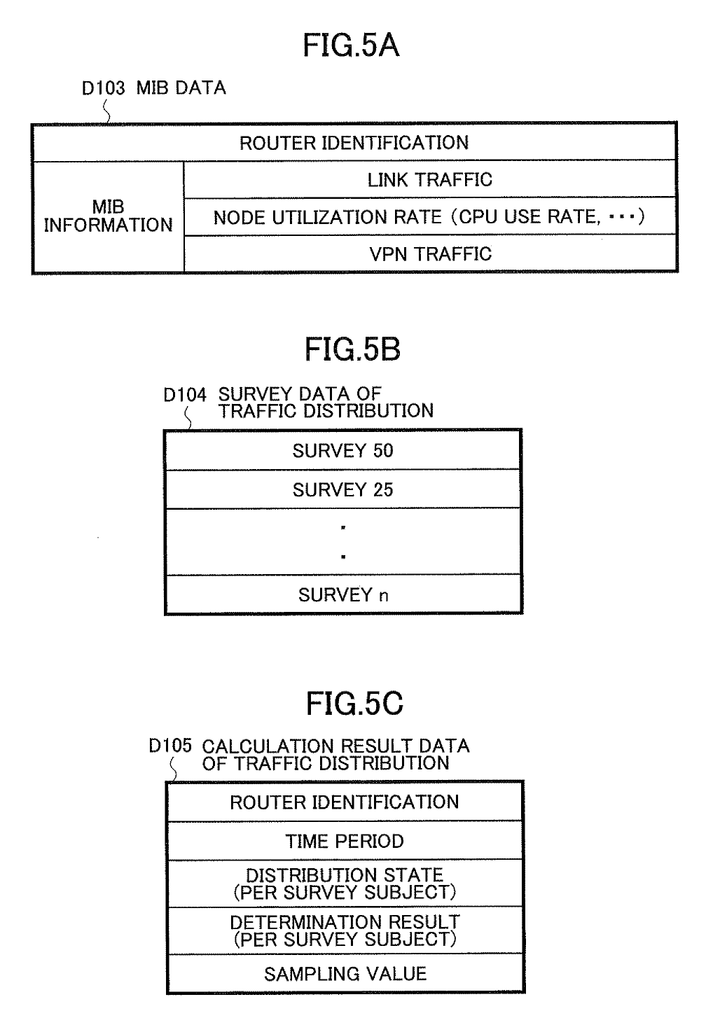

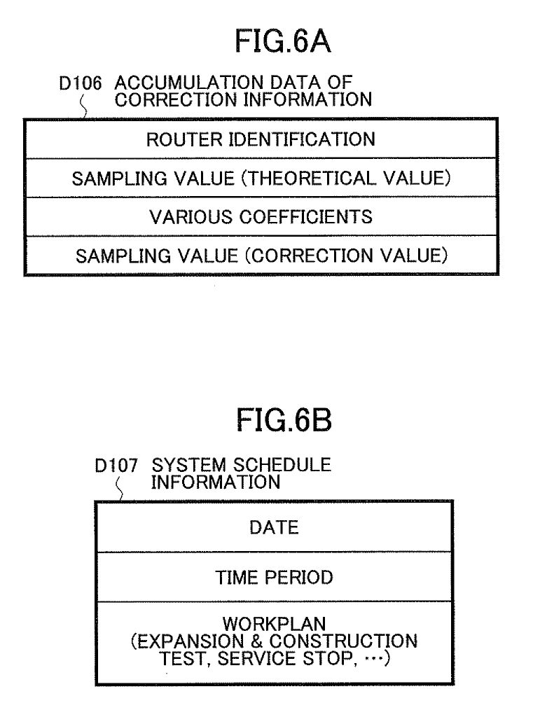

Various data structures of data described with reference to FIG. 3 will be illustrated in FIG. 4A through FIG. 4C, FIG. 5A through FIG. 5C, and FIG. 6A and FIG. 6B.

In FIG. 4A, the accumulated data D100 of the traffic measurement results retain raw data of the flow information collected from each of the routers (routers CR1 through CR3 and the like in FIG. 1A), and include “DATE” (year, month, and date) and “TIME PERIOD” when a collection is made, and “FLOW INFORMATION (TRAFFIC STATE DATA)” of the label unit of the MPLS.

In FIG. 4B, the process counter data D101 for the traffic measurement include various counters and flags necessary for the process. As the counters, the process counter data D101 include “ROUTER COUNTER” for specifying a router being a process subject, “FINAL VALUE OF ROUTER COUNTER” indicating a final value of the router counter, “COLLECTION COUNTER” for specifying a time period of a process subject, “FINAL VALUE OF COLLECTION COUNTER” indicating a final value of the collection counter, “DISTRIBUTION SURVEY COUNTER” for specifying a subject of the distribution survey, and “FINAL VALUE OF ENTIRE SURVEY COUNT” indicating a final value of the distribution survey counter. Also, as the flags, the process counter data D101 include “END FLAG OF SURVEY RESULT” indicating that the distribution survey ends, “FLAG OF MEASUREMENT IN OPERATION” indicating that the measurement is in operation, “SPECIAL ANALYSIS FLAG” indicating whether or not a special analysis process is required, “SURVEY DETERMINATION FLAG” indicating that a survey determination is made, “CONFORMITY FLAG” indicating that the sampling value is conformed, and “ADAPTATION FLAG” indicating that the sampling value is adapted to the sampling data.

In FIG. 4C, the basic calculation data D102 of the traffic measurement results retain data to be a foundation of the later processes, and include “ROUTER IDENTIFICATION” specifying a router, “DATE” (year, month, and date) and “TIME PERIOD” when a collection is made, “PACKET NUMBER” of a collection result, “ERROR RATE (THEORY)” calculated from the packet number, “MEASUREMENT DELAY TIME” indicating time consumed for the measurement, “CPU USE RATE” calculated from the MIB information, and “SAMPLING VALUE” used for the collection.

In FIG. 5A, the MIB data D103 retain the MIB information acquired from each of the routers, and include “ROUTER IDENTIFICATION” specifying a router, and “MIB INFORMATION” indicating collected MIB information. “MIB INFORMATION” further includes “LINK TRAFFIC”, “NODE UTILIZATION RATE (CPU, USE RATE, . . . )”, and “VPN TRAFFIC”. “CPU USE RATE” is included in “NODE UTILIZATION RATE”.

In FIG. 5B, the survey data D104 of the traffic distribution retain data of the survey range used for the distribution survey, and include contents such as “SURVEY 50”, “SURVEY 25”, . . . , and “SURVEY n”. A numeral portion indicates the survey range (survey degree) referred to for determining a distribution.

In FIG. 5C, the calculation result data D105 of the traffic distribution retain results from conducting the distribution survey for each of the routers, and include “ROUTER IDENTIFICATION” for identifying a router, “TIME PERIOD” when a collection is made, “DISTRIBUTION STATE (PER SURVEY SUBJECT)”, “DETERMINATION RESULT (PER SURVEY SUBJECT)”, and “SAMPLING VALUE” used for the collection.

In FIG. 6A, the accumulation data D106 of the correction information retain a correction result of the sampling value, and include “ROUTER IDENTIFICATION” specifying a router, “SAMPLING VALUE (THEORETICAL VALUE)” being a theoretical value acquired from the distribution result, “VARIOUS COEFFICIENTS” indicating a multiplication rate used in a conformity process or a special analysis process (special diagnosis process), and “SAMPLING VALUE (CORRECTION VALUE)” acquired from multiplying various coefficient by the sampling value (theoretical value).

In FIG. 6B, the system schedule information D107 is information indicating a work plan such as expansion, a construction test, a service stop, and the like, and includes “DATE” (year, month, and date) and “TIME PERIOD” of the work plan, and “WORK PLAN” including contents of the work plan.

### <Operations>

In the following, operations according to the embodiment will be described.

The flow information accumulation part B11 conducts a sampling correction with respect to the routers being subjects, and accumulates the flow information collected from each of the routers in the accumulated data D100 of traffic measurement results. Then, after the collection being performed in the certain period is completed, the flow information accumulation part B11 activates the correction control process to be conducted by the correction control process part B100.

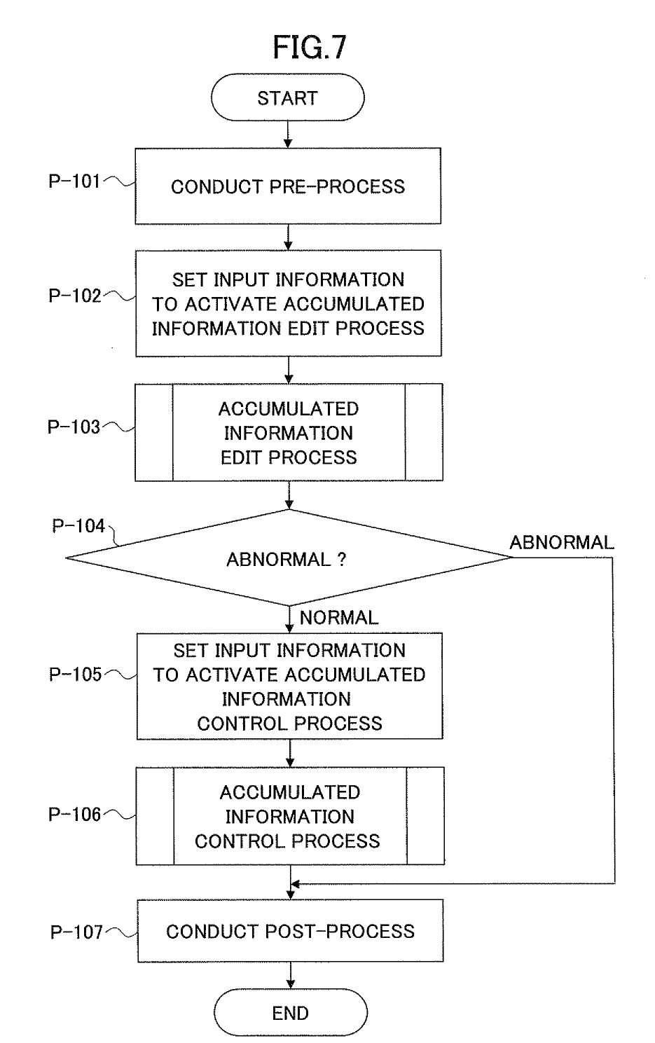

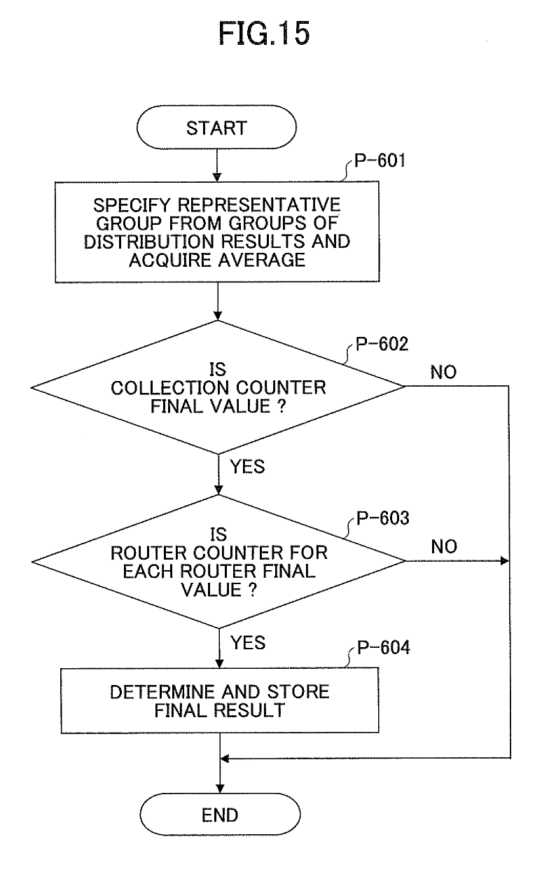

In the following, the correction control process by the correction control process part B100 and processes activated from the correction control process will be described in accordance with flowcharts depicted in FIG. 7 through FIG. 13, and FIG. 15 through FIG. 20.

In FIG. 7, after the correction control process initializes the process counter data D101 for the traffic measurement, which are necessary for various processes by a pre-process (step P-101), the correction control process sets input information to an activate accumulated information edit process (step P-102). Then, the accumulation information edit process is started by the accumulated information edit process part B101 (step P-103).

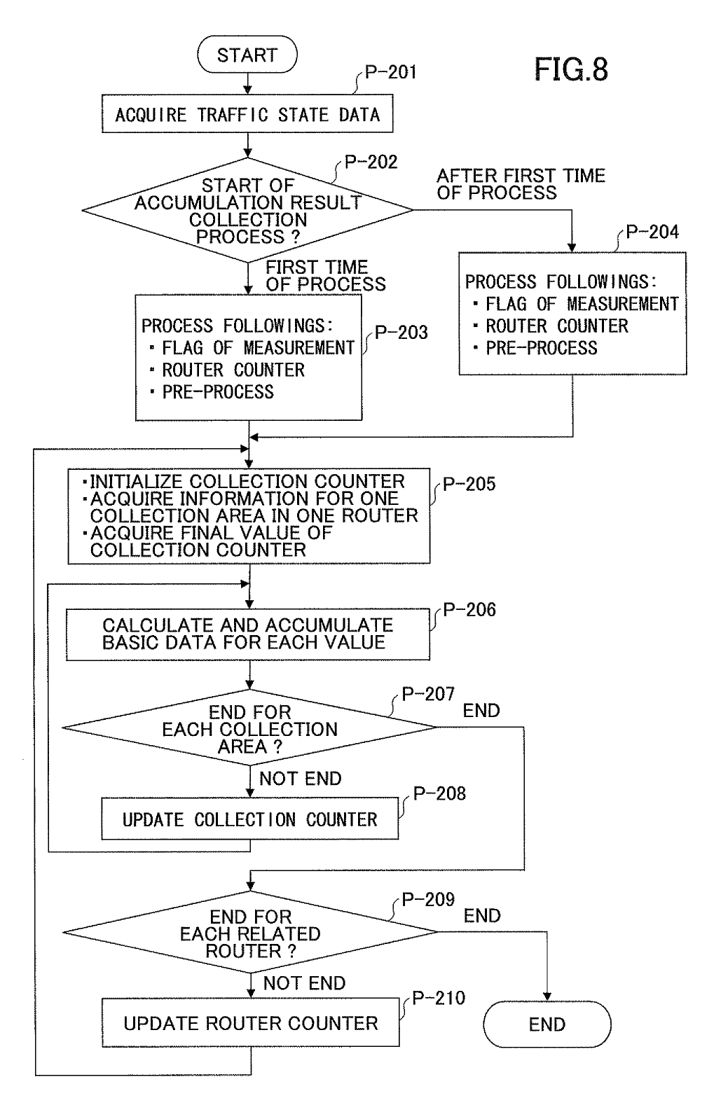

In FIG. 8, the accumulated information edit process part B101 acquires the traffic state data from the accumulated data D100 of traffic measurement results (step P-201). Then, the accumulated information edit process part B101 determines by referring to the date (year, month, and date) and the time period of the traffic state data being accumulated whether or not a accumulation result collection process is started, that is, a time period for starting correction control will be next (step P-202).

In a case in which this process is conducted a first time and the time period for starting the correction control will be next, the accumulated information edit process part B101 conducts initial settings of the flag of the measurement in operation (a measurement will be started next time) and the router counter (a loop process conducted one time for each router), and initializes other counters and flags (the pre-process is conducted), and the like (step P-203).

On the other hand, in a case in which the accumulated information edit process has been already performed in the time period for starting the correction control after the process is conducted the first time, the accumulated information edit process part B101 sets initial settings to the flag of the measurement in operation (the measurement is being conducted) and the router counter, and initializes other counters and flags (the pre-process is conducted), and the like (step P-204).

Next, the accumulated information edit process part B101 initializes the collection counter utilized in one router loop and acquires related information (step P-205). The accumulated information edit process part B101 obtains a traffic measurement result as basic calculation data by a calculation using necessary items for a measurement result, that is, the packet number, the measurement delay time, and the like, and accumulates the measurement results in the basic calculation data D102 of the traffic measurement results (step P-206). The error rate is calculated and accumulated later in an accumulated information calculation process by the accumulated information calculation process part B103. At this point, the CPU use rate cannot be acquired and thus, is not a subject to process.

After the above calculation process of the basic data ends, the accumulated information edit process part B101 determines whether or not the process ends for each collection area (step P-207). The collection counter is used in this determination.

When the process for all of the collection areas has not ended, the accumulated information edit process part B101 updates the collection counter (step P-208), and repeats the process (from step P-206) for a next collection area.

When the process has ended for all of the collection areas, the accumulated information edit process part B101 determines whether or not a process for all of the related routers ends (step P-209). The router counter is used for this determination.

When the process for all of the related routers has not ended, the accumulated information edit process part B101 updates the router counter (step P-210), and conducts the above process (starting from the step P-205) for a next router.

When the process for all of the related routers has ended, the accumulated information edit process by the accumulated information edit process part B101 is terminated, and returns to a call origin which is the correction control process by the correction control process part B100.

Returning to FIG. 7, the correction control process returned from the accumulated information edit process determines whether a result includes a normal or an abnormal end of the accumulated information edit process (step P-104).

If the result includes the abnormal end of the accumulated information edit process, the correction control process conducts a later process (step P-107), is terminated, and goes back to the existing flow control process conducted by the flow information accumulation part B11.

If the result includes the normal end of the accumulated information edit process, the correction control process sets input information to activate an accumulated information control process (step P-105). Then, the accumulated information control process is started by the accumulated information control process part B102 (step P-106).

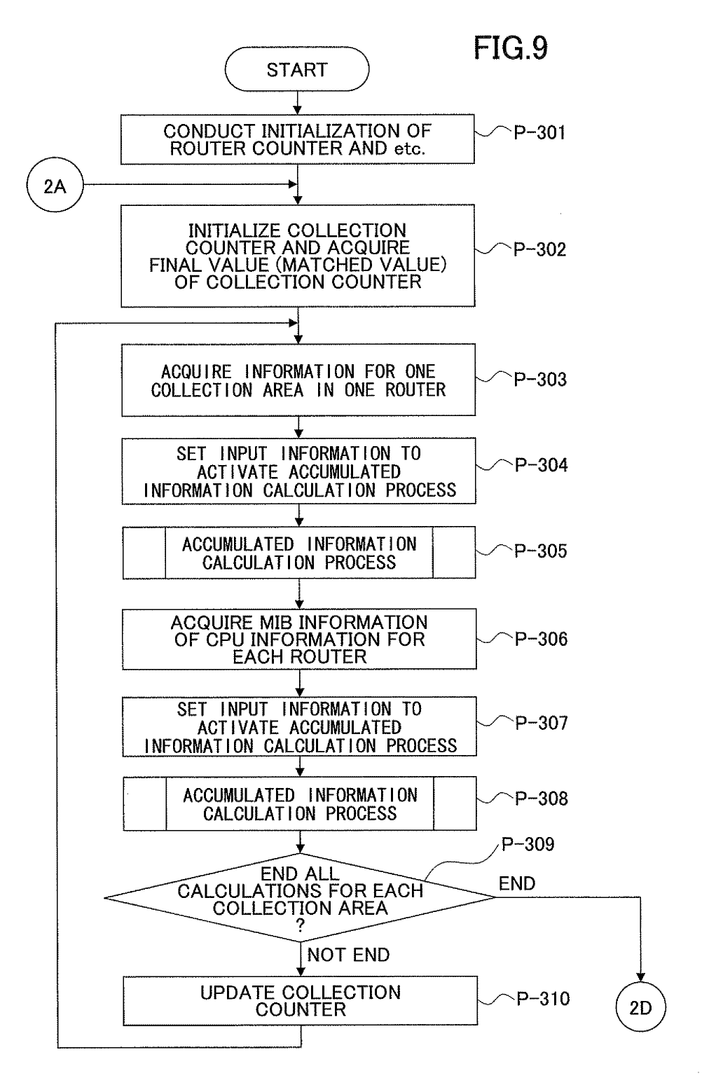

In FIG. 9, the accumulated information control process part B102 initializes the router counter, acquires the final value of the router counter, and conducts a pre-process (step P-301).

Subsequently, the correction control process initializes the collection counter utilized in one router loop, and acquires the related information (step P-302).

Next, the correction control process acquires information of one router for one collection area corresponding to the collection counter (step P-303).

After that, the correction control process sets input information to activate the accumulated information calculation process (step P-304), and activates the accumulated information calculation process by the accumulated information calculation process part B103 (step P-305).

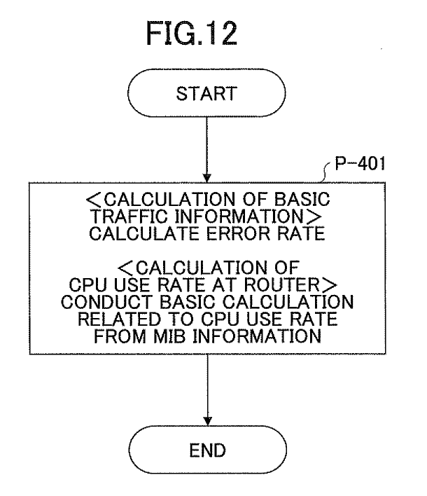

In FIG. 12, the accumulated information calculation process by the accumulated information calculation process part B103 determines based on an input condition to calculate the basic traffic information, acquires an error rate of the packet number in the traffic collection results accumulated in the accumulated data D100 of the traffic measurement results, and accumulates the error rate of the packet number in the basic calculation data D102 of the traffic measurement results (step P-401). After that, the accumulated information calculation process is terminated, and returns to a call origin which is the accumulated information control process by the accumulated information control process part B102.

Returning to FIG. 9, the correction control process acquires the MIB information of the CPU information for each router from the MIB data D103 which are acquired for each router by a process conducted in another time period (step P-306). Then, the correction control process sets input information to activate the accumulated information calculation process (step P-307), and activates the accumulated information calculation process by the accumulated information calculation process part B103 again (step P-308).

In FIG. 12, the accumulated information calculation process by the accumulated information calculation process part B103 determines, based on input conditions, to calculate the CPU use rate, conducts a basic calculation related to the CPU use rate from the MIB information, and accumulates the CPU use rate in the basic calculation data D102 of the traffic measurement results (step P-401). After that, the accumulated information calculation process is terminated, and returns to a call origin which is the accumulated information control process by the accumulated information control process part B102.

Returning to FIG. 9, the accumulated information control process by the accumulated information control process part B102 determines whether or not all calculations end for all of the collection areas (step P-309). The collection counter is used for this determination.

If it is determined that all calculations have not ended for all of the collection areas since the collection counter has not reached the final value, the accumulated information control process updates the collection counter (step P-310), and conducts the above calculation processes (starting from the step P-303) for a next collection area.

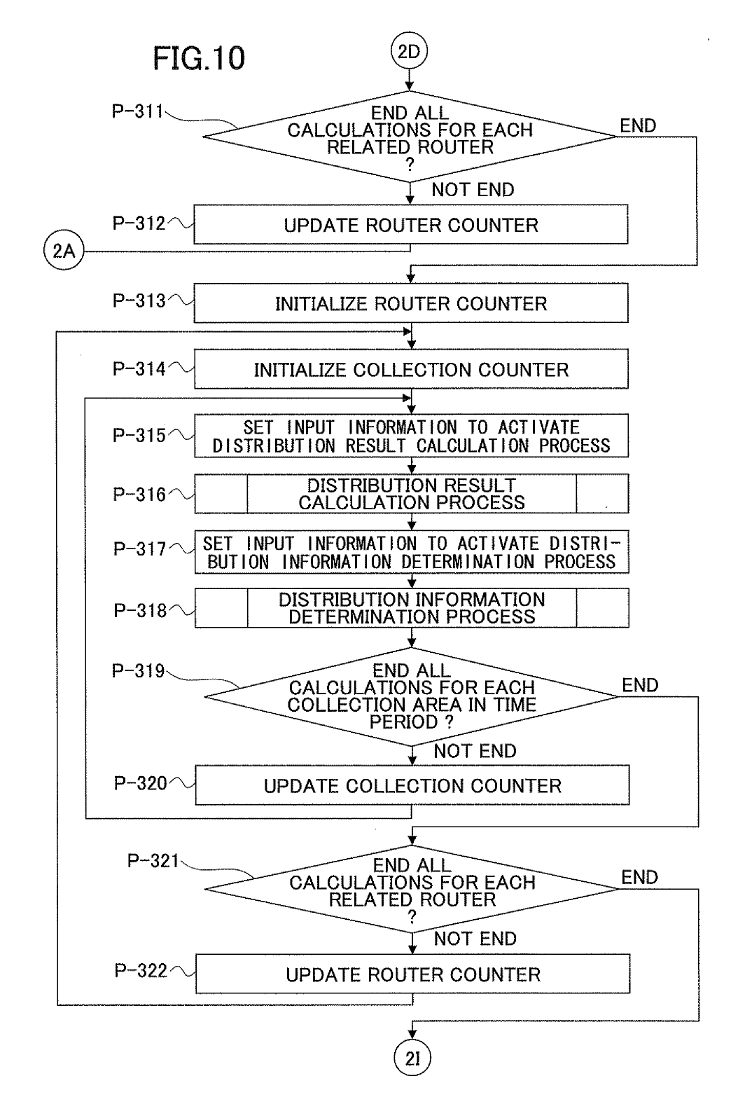

On the other hand, if it is determined that all calculations have ended for all of the collection areas since the collection counter reaches the final value, in FIG. 10, the accumulated information control process determines whether or not all calculations have ended for all of the related routers (step P-311). The router counter is used for this determination.

If all calculations have not ended for all of the related routers, the accumulated information control process updates the router counter (step P-312), and repeats the above process (starting from the step P-302 in FIG. 9) for a next router.

On the other hand, if all calculations have ended for all of the related routers, the accumulated information control process makes transition to a distribution result calculation process by the distribution result calculation process part B104.

First, the accumulated information control process by the accumulated information control process part B102 initializes the router counter (step P-313), and initializes the collection counter (step P-314). If the distribution calculation process including accumulated past results is conducted a first time, the final value of the collection counter is set as [past days×24]+[remaining time period]. If the distribution result calculation process has been already conducted, the final value is set to be two.

Next, the accumulated information control process sets input information to activate the distribution result calculation process (step P-315), and activates the distribution result calculation process by the distribution result calculation process part B104 (step P-316).

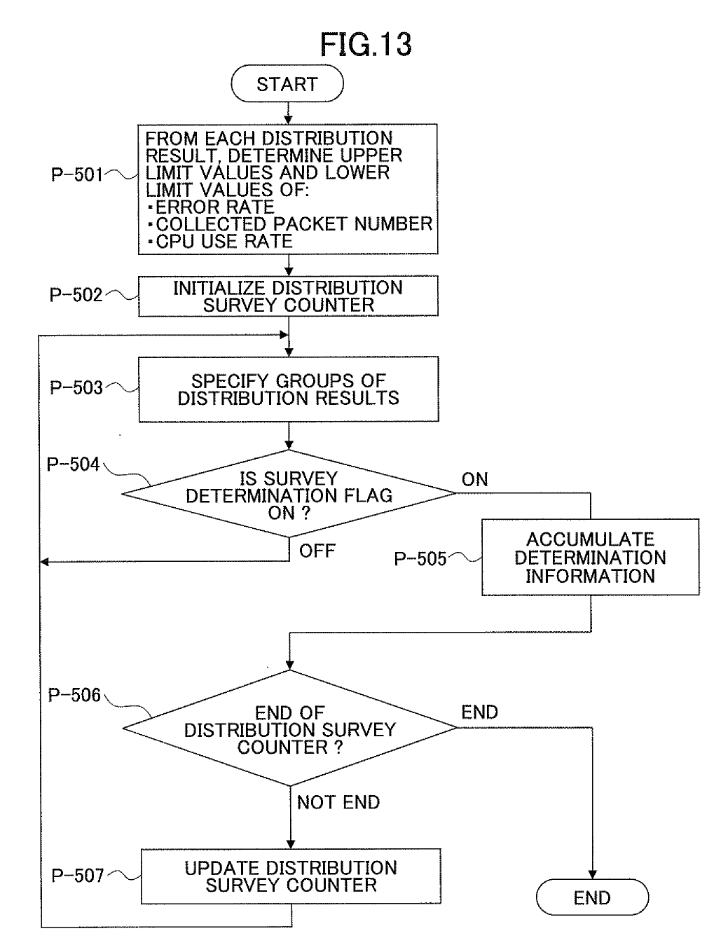

In FIG. 13, the distribution result calculation process part B104 conducts a process for determining upper limit values and lower limit values of the error rate, a collected packet number, and the CPU use rate from each distribution result collected every one hour (step P-501).

Next, the distribution result calculation process part B104 initializes the distribution survey counter (step P-502). In this case, a process is sequentially conducted for the survey 50, the survey 25, the survey 10, the survey 5, . . . , the survey n until a function is determined. The survey range is acquired from the survey data D104 of the traffic distribution.

Subsequently, the distribution result calculation process part B104 specifies the groups of the distribution results (step P-503). In detail, the following processes will be conducted.
(1) A process is conducted to determine how may value groups of the distribution results exist. That is, the process acquires the number of the groups of the distribution results being collected and the number of distributions, by a function process. In this case, the process is repeated by an input survey condition in gradually narrowing the survey range in an order of the survey 50, the survey 25, the survey 10, the survey 5, the survey 3, the survey 1, the survey 0.7, the survey 0.5, the survey 0.3, . . . , and the survey n. In processing in this order, gaps among the groups may appear. When it becomes difficult to make a group in a narrower survey range, a result in one survey range just before the narrower survey range is applied.
(2) In accordance with a condition of the above item (1), a width of the distribution is acquired for each group, and information is collected to determine in which point an average exists.
(3) Surveys regarding processes of the above items (1) and (2) are conducted for all conditions of an input.
(4) As a result of the surveys from the above item (1) to (3), if all groups are determined, the survey determination flag is set to be “ON” (survey end). If the surveys have not ended, the surveys in the item (1) through (4) are repeated.
(5) If a distribution state cannot be determined from a distribution value result in a process flow from the item (1) through (4), groups are further searched, and groups to be surveyed are finally determined.

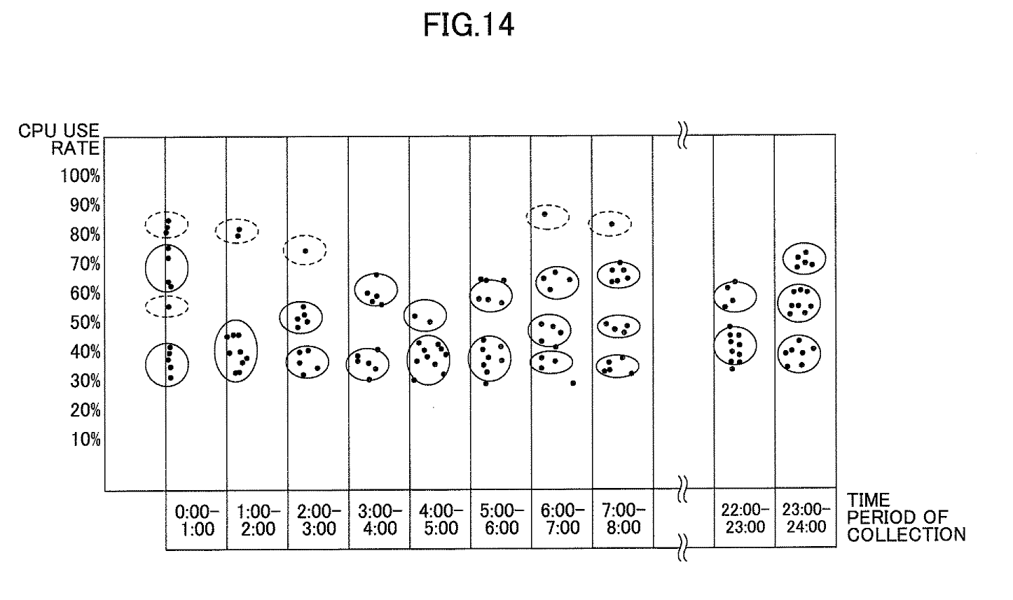

FIG. 14 is a diagram illustrating a brief overview of the distribution result calculation process. In FIG. 14, the CPU use rate is illustrated. The CPU use rates on multiple past dates (year, month, and date) are distributed on the time periods. For each time period, groups circled by a solid line are specified as normal groups. Groups, which are excluded from the normal groups and circled by a dashed line, are specified as subject groups of the special analysis process which will be described later.

Returning to FIG. 13, the distribution result calculation process B104 confirms that the survey determination flag is set (step P-504).

If the survey determination flag is “OFF” indicating that the survey has not ended, the process is repeated from conducting the survey of the distribution state (starting from step P-503). Data of a distribution result are surveyed until the survey end is set with the survey determination flag.

If the survey determination flag is “ON” indicating that the survey ends, the distribution result calculation process part B104 accumulates determination information in the calculation result data D105 of the traffic distribution retain results (step P-505).

Next, the distribution result calculation process part B104 determines that the survey ends, by checking whether or not the distribution survey counter reaches the final value (step P-506).

If the distribution survey counter does not indicate the survey end, the distribution result calculation process part B104 updates the distribution survey counter (step P-507), and conducts a next survey (starting from step P-503).

When the distribution survey counter indicates the survey end and the survey for all distribution results is completed for one collection survey area, the distribution result calculation process is terminated, and returns to a call origin which is the accumulation information control process by the accumulation information control process part B102.

Returning to FIG. 10, the accumulation information control process part B102 sets input information to activate the distribution result determination process (step P-317), and activates the distribution information determination process conducted by the distribution information determination process part B105 (step P-318).

In FIG. 15, the distribution information determination process part B105 specifies a representative group from the groups of the distribution results and acquires an average (step P-601), and accumulates a result in the calculation result data D105 of the traffic distribution. In detail, the following processes are conducted.
(1) Regarding all measurement subject types such as the CPU use rate, the error rate of the packets, the packet number, etc., the representative group is specified from distribution data groups by a majority decision based on the number of distributions included in each group, and the average in the representative group is acquired.
(2) The special analysis flag is set to outstanding groups external from the specified group.

Next, the distribution information determination process part B105 determines that a current determination process is a last process, by checking whether or not the collection counter has ended (step P-602).

If the collection counter has ended, subsequently, the distribution information determination process part B105 determines that a current process for the routers is a last process, by checking whether or not the router counter has ended (step P-603).

If the router counter has ended, as a final result, the distribution information determination process part B105 determines final averages for the packet number, the error rate of the packets, and the CPU use rate from valid values being determined in distribution result values for each collection area for each time period of each router, and stores the final values in the calculation result data D105 of the traffic distribution (step P-604). Accordingly, the distribution information determination process is terminated, and returns to a call origin which is the accumulated information control process by the accumulated information control process part B102.

If the collection counter has not ended or if the router counter has not ended, the distribution information determination process is terminated, and returns to a call origin which is the accumulated information control process by the accumulated information control process part B102.

In FIG. 10, the accumulated information control process part B102 determines whether or not the process for each collection area in the time period is completed (step P-319). If not completed, the accumulated information control process part B102 determines to update the collection counter (step P-320) and returns to the distribution result calculation process (starting from the step P-315).

On the other hand, if completed, the accumulated information control process part B102 determines whether or not all calculations have ended for all of the related routers (step P-321). If the calculations are not completed for all of the related routers, the accumulated information control process part B102 updates the router counter (step P-322), and goes back to initializing the collection counter (starting from the step P-314).

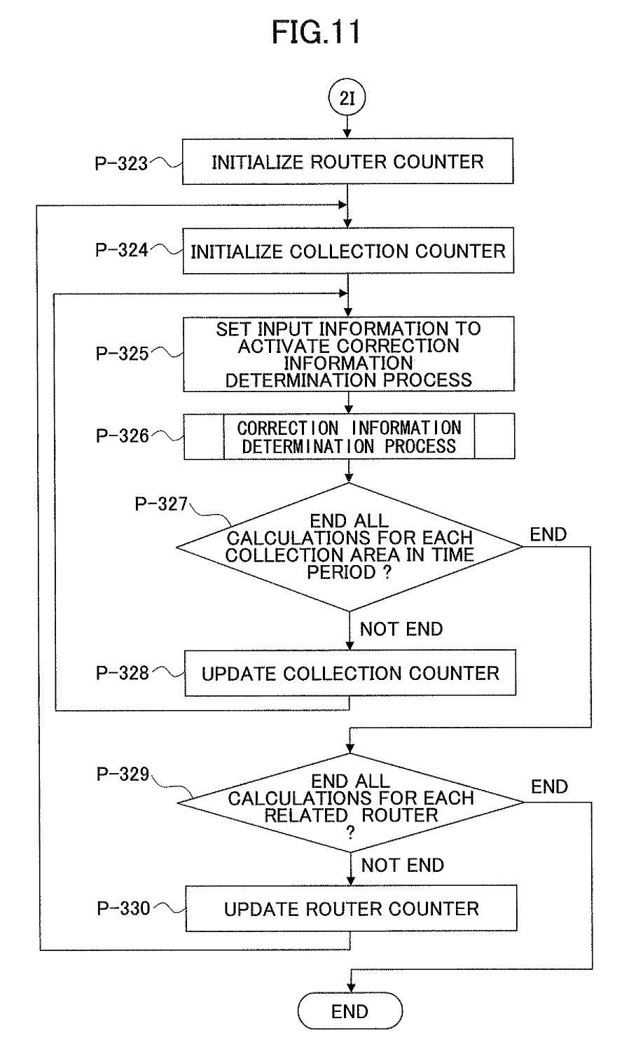

If the calculations are completed for all of the related routers, the accumulated information control process part B102 makes the transition to the correction control process in FIG. 11.

First, the accumulated information control process part B102 initializes the router counter (step P-323). Next, the accumulated information control process part B102 initializes the collection counter (step P-324).

Then, the accumulated information control process part B102 sets input information to activate the correction information determination process (step P-325), and activates the correction information determination process conducted by the correction information determination process part B106 (step P-326).

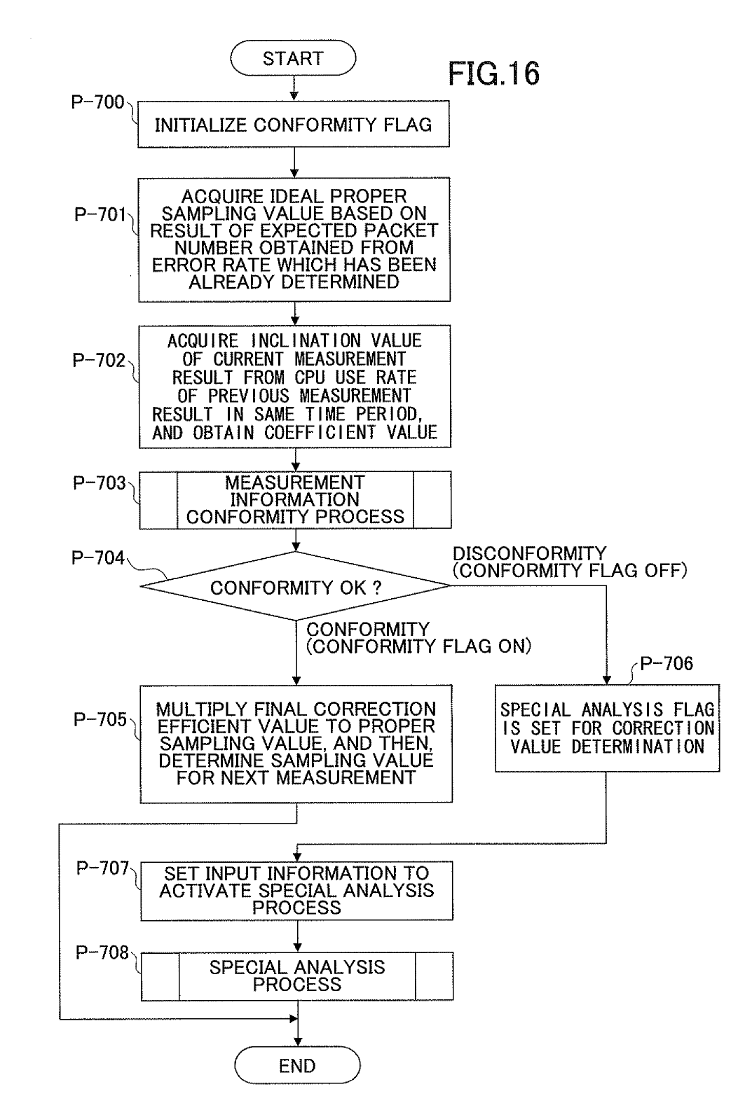

In FIG. 16, first, the correction information determination process part B106 initializes the conformity flag (=0) (step P-700).

Next, an ideal proper sampling value is acquired based on a result of an expected packet number obtained from the error rate which has been already determined, and is accumulated in the accumulation data D106 of the correction information (step P-701).

Subsequently, an inclination value (angle) of a current measurement result value is acquired from the CPU use rate of a previous measurement result value in the same time period, and a coefficient is also obtained with respect to the inclination value (step P-702).

Next, based on this current measurement result value, the correction information determination process part B106 activates the measurement information conformity process conducted by the measurement information conformity process part B107 (step P-703). A conformity check is performed with respect to the current measurement result value.

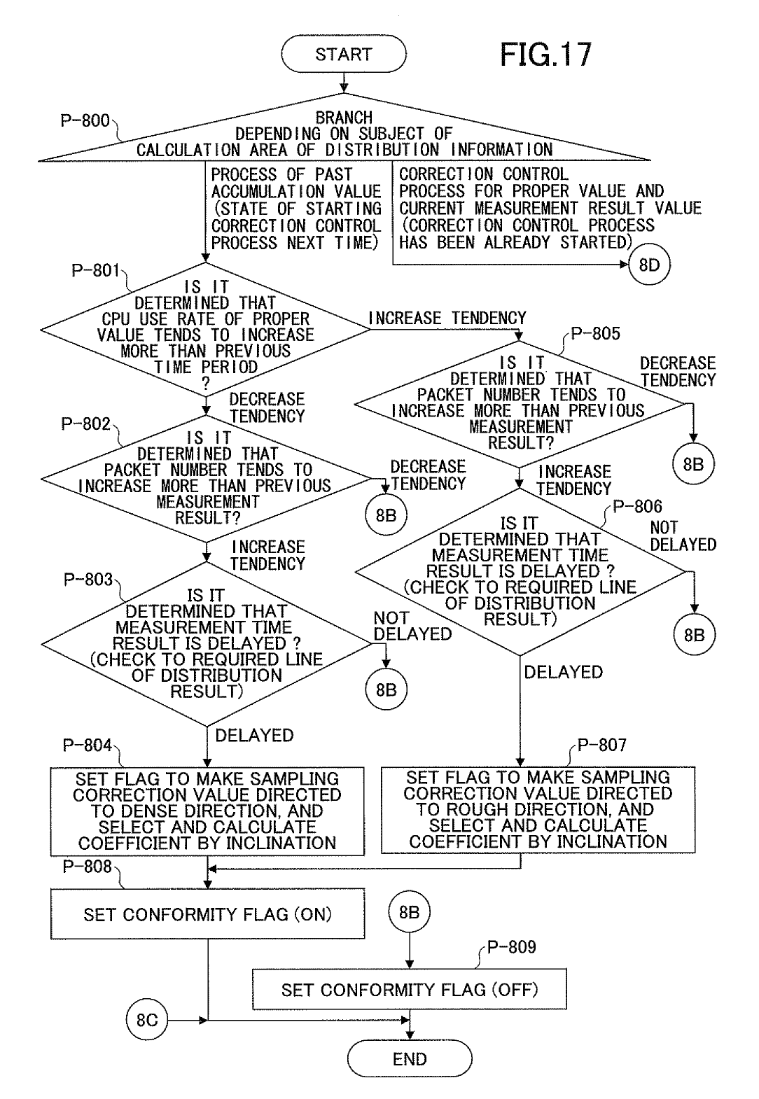

In FIG. 17, the measurement information conformity process part B107 determines a subject of a calculation area of distribution information from the survey data D104 of the traffic distribution and the accumulation data D106 of the correction information, and branches depending on the subject (step P-800).

In a case of a calculation process of a past accumulation value (the correction control process is started next time), it is determined whether or not the CPU use rate of the proper value tends to increase more than a previous time period (step P-801).

If the CPU use rate tends to decrease, it is determined whether or not the packet number tends to increase more than a previous measurement result in the same time period (step P-802).

If the CPU use rate tends to increase, it is determined whether or not a measurement time result is delayed with respect to a required line of the distribution result (step P-803).

If the measurement time result is delayed, the conformity flag is set to make a sampling correction value directed to a dense direction, and a sampling coefficient value by an inclination value (angle) is also calculated (step P-804).

On the other hand, if the CPU use rate of the proper value tends to increase more than the previous time period, it is determined whether or not the packet number tends to increase more than the previous measurement result in the same time period (step P-805).

If the packet number tends to increase, it is determined with respect to the required line of the distribution result whether or not the measurement time result is delayed (step P-806).

On the other hand, if the measurement time result is delayed, the conformity flag is set to make the sampling correction value directed to a rough direction, and the sampling coefficient value is also calculated for each inclination value (angle) (step P-807).

Next, the measurement information conformity process part B107 sets the conformity flag (conformity state=1:ON) (step P-808), and terminates the measurement information conformity process.

Also, when it is determined by the above determination of the packet number (steps P-802 and P-805) that the packet number tends to decrease more than the previous measurement result in the same time period, or when it is determined by the above determination of a delay of the measurement time result (steps P-803 and P-806) that the measurement time result is not delayed, the measurement information conformity process part B107 sets the conformity flag (inconformity state=0:OFF) (step P-809), and terminates the measurement information conformity process. In this case, the special analysis process is conducted by the special analysis process part B108.

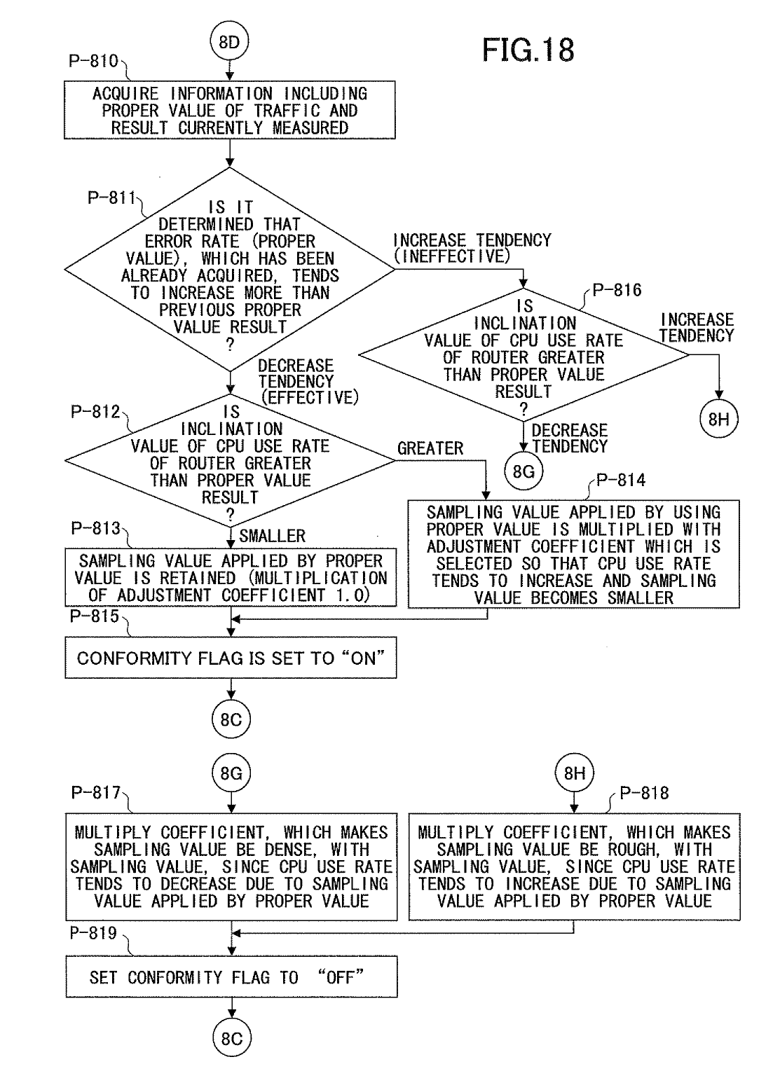

On the other hand, in the branch depending on the subject of the calculation area of the distribution information (step P-800), in a case of conducting the correction control process for the proper value and the current measurement result value (in a case in which the correction control process has been already started), a process is conducted for a correction adjustment between a proper value level being already fixed and a result being measured (FIG. 18).

In FIG. 18, the measurement information conformity process part B107 acquires information including the proper value of traffic and a result currently measured in each collection time period (step P-810).

After that, it is determined whether the error rate (proper value), which has been already acquired, tends to increase more than a previous proper value result (step P-811).

If the error rate tends to decrease (is effective), it is determined that a sampling value result, which has been already applied, is appropriate, and it is determined whether or not an inclination value of the CPU use rate of the router is greater than the proper value result (step P-812).

If the inclination value of the CPU use rate is smaller, since it is determined that the CPU use rate tends to decrease, the sampling value applied by the proper value is retained (multiplication of an adjustment coefficient 1.0) (step P-813).

On the other hand, if the inclination value of the CPU use rate of the router is greater than the proper value result, since it is determined that an error rate is small and the CPU use rate tends to increase, the sampling value applied by using the proper value is multiplied with the adjustment coefficient which is selected so that the CPU use rate tends to increase and the sampling value becomes smaller (step P-814).

Subsequently, the conformity flag is set to “ON” (conformity=1) (step P-815). Returning to FIG. 17, the measurement information conformity process part B107 terminates the measurement information conformity process.

On the other hand, in FIG. 18, in a case in which the error rate (proper value), which has been already acquired, tends to increase more than the previous proper value result (ineffective), in the same manner described above, it is determined that the inclination value of the CPU use rate of the router is greater than the proper value result (step P-816).

If it is determined that the CPU use rate tends to decrease, since the error rate is great and the CPU use rate tends to decrease, a coefficient to make the sampling value applied by the proper value be dense is multiplied with the sampling value, and its result is set as the proper value (step P-817).

If it is determined that the inclination value of the CPU use rate of the router tends to increase, since the error rate is great and the CPU use rate tends to increase, a coefficient to make the sampling value applied by the proper value be rough is multiplied with the sampling value, and its result is set as the proper value (step P-818).

After that, the conformity flag is set to “OFF” (conformity=0) (step P-819). Returning to FIG. 17, the measurement information conformity process part B107 terminates the measurement information conformity process and returns to the correction information determination process.

In FIG. 16, the correction information determination process part B106 checks a conformity result (step P-704).

If this check result indicates the conformity (conformity flag=ON:1), a final correction coefficient value is multiplied to the proper sampling value, and then, the sampling value for a next measurement is determined (step P-705). The correction information determination process part B106 stores its determination value in the accumulation data D106 of the correction information, and terminates the correction information determination process.

On the other hand, if the check result indicates nonconformity (conformity flag=OFF:0), the correction information determination process part B106 sets the special analysis flag (=1) for a correction value determination (step P-706), sets input information to activate the special analysis process (step P-707), and activates the special analysis process conducted by the special analysis process part B108 (step P-708).

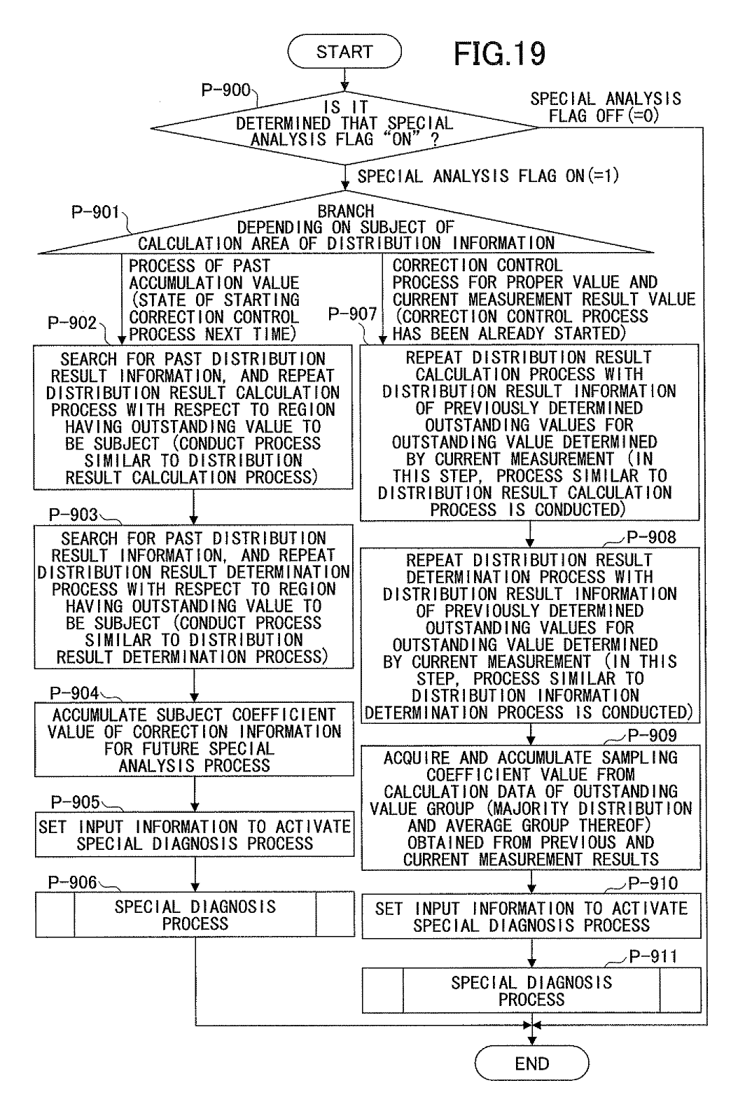

In FIG. 19, first, the special analysis process part B108 determines whether or not the special analysis flag is “ON” (=1), to make an execution conformity in a process (step P-900).

In this determination, if the special analysis flag is “ON”, it is assumed that the special analysis process is required and the following special analysis is conducted.

First, the special analysis process part B108 branches depending on the calculation area of the distribution information of the traffic distribution calculation result data (step P-901).

In a case of a calculation process of the past accumulation value (the correction control process is started next time), past distribution result information is searched for, and the distribution result calculation process is repeated with respect to a region having outstanding value to be subject (step P-902). That is, the special analysis process part B108 conducts a process similar to the distribution result calculation process by the distribution result calculation process part B104.

Next, past distribution result information is searched for, and the distribution result determination process is repeated (step P-903). That is, the special analysis process part B108 conducts a process similar to the distribution result determination process conducted by the distribution result determination process part B105.

After that, the special analysis process part B108 accumulates a subject coefficient value of correction information for a future special analysis process in the accumulation data D106 of the correction information (step P-904).

Subsequently, the special analysis process part B108 sets input information to activate the special diagnosis process (step P-905), and activates the special diagnosis process conducted by the special diagnosis process part B109 (step P-906). The special diagnosis process is further conducted.

In a case of conducting the correction control for the proper value and the current measurement result (the correction control process has been already started), the distribution result calculation process is repeated with the distribution result information of previously determined outstanding values for an outstanding value determined by a current measurement (step P-907). That is, the special diagnosis process part B109 conducts a process similar to the distribution result calculation process conducted by the distribution result calculation process part B104.

Next, the distribution result determination process is repeated with the distribution result information of previously determined outstanding values for the outstanding value determined by the current measurement (step P-908). That is, the special diagnosis process part B109 conducts a process similar to the distribution information determination process by the distribution information determination process part B105.

After that, the special diagnosis process part B109 acquires the sampling coefficient value from calculation data and the like of an outstanding value group (a majority distribution and an average group thereof) obtained from the previous and current measurement results and accumulates the sampling coefficient value in the accumulation data D106 of the correction information (step P-909).

Subsequently, the special diagnosis process part B109 sets input information to activate the special diagnosis process (step P-910), and activates the special diagnosis process conducted by the special diagnosis process part B109 (step P-911). A further diagnosis process is conducted.

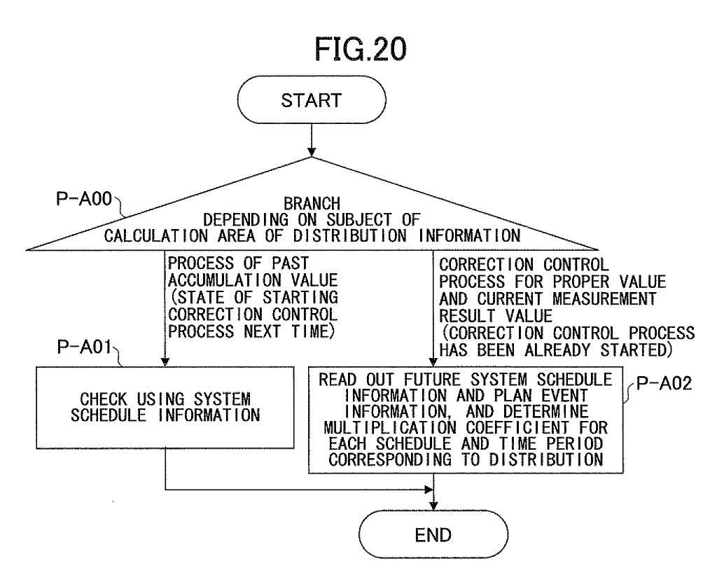

In FIG. 20, first, the special diagnosis process part B109 branches depending on the subject of the calculation area of the distribution information of the traffic distribution calculation result data (step P-A00).

In a case of the calculation process of the past accumulation value (the correction control process is started next time), a check is conducted using the system schedule information D107 (step P-A01). In detail, the following processes are conducted.
(1) Plan event information is read from the system schedule information D107, and a check is started for all past information regarding a schedule and timetable corresponding to a distribution in interest. If by the timetable of a check result, it is determined that the distribution of the time period is valid, distribution data are recognized as valid information. An adequate sampling value is determined again as the sampling value for each collection area from a multiplication coefficient, and is accumulated in the accumulation data D106 of the correction information.
(2) If the check result does not indicate a valid result, an original sampling value, which is acquired as an initial distribution result from the accumulation data D106 of the correction information, is set, accumulated, and utilized for a next traffic collection result.

On the other hand, in a case of conducting the correction control for the proper value and the current measurement result (the correction control process has been already started), future plan event information is read from the system schedule information D107, regarding the schedule and timetable for a distribution in interest, after the multiplication coefficient is acquired, set as a sampling correction value, and accumulated in the accumulation data D106 of the correction information to utilize for the next traffic collection result (step P-A02).

After that the special diagnosis process part B109 terminates the special diagnosis process and returns to the special analysis process conducted by the special analysis process part B108. Moreover, the special analysis process part B108 terminates the special analysis process and returns to the correction information determination process conducted by the correction information determination process part B106. Furthermore, the correction information determination process part B106 terminates the accumulated information control process conducted by the accumulated information control process part B102.

In FIG. 11, the accumulation information control process part B102 determines whether or not all calculations end for all of the collection areas (step P-327).

If all calculations have not ended, the accumulation information control process part B102 updates the collection counter (step P-328), and repeats from the process for setting input information to activate the correction information determination process (in the step P-325).

If all calculations end, the accumulation information control process part B102 determines whether or not all calculations end for all of the related routers (step P-329).

If all calculations have not ended for all of the related routers, the accumulation information control process part B102 updates the router counter (step P-330), and repeats from the process for initializing the collection counter (in the step P-324).

If all calculations end, the accumulation information control process part B102 terminates the accumulation information control process, and returns to the correction control process conducted by the correction control process part B100.

Returning to FIG. 7, the correction control process part B100 conducts a post-process (step P-107), terminates all processes, and returns to the existing flow control process conducted by the flow information accumulation part B11.

As described above, with respect to all routers, for each collection time period, a degree of accuracy is finely defined, and the error rate is made to be gradually smaller and to be within a target value (for example, 5%).

By conducting the above-described processes, it is possible to acquire the distribution result whose accuracy is improved.

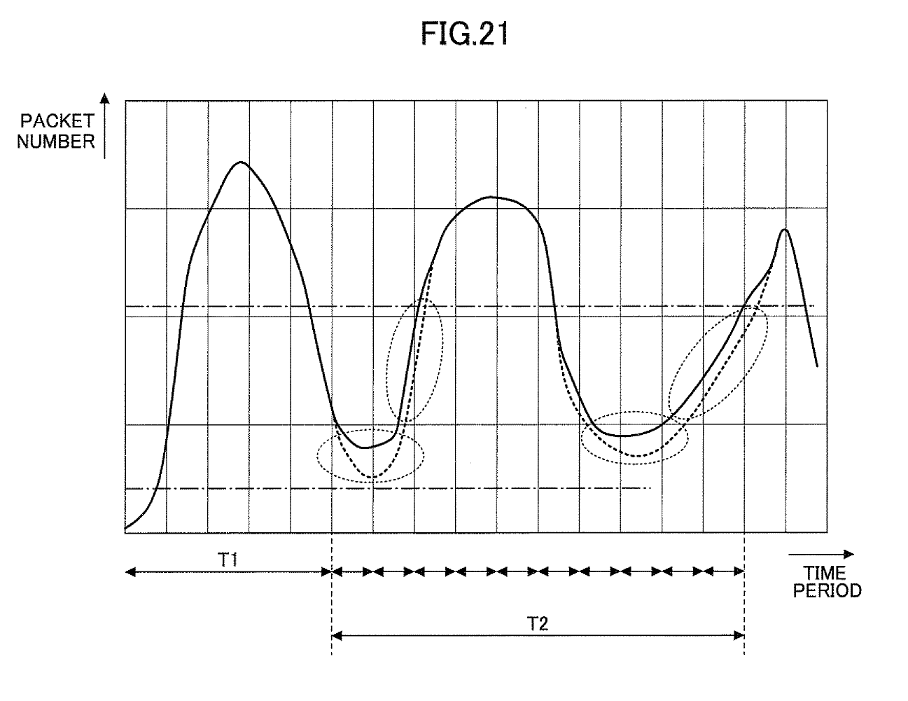

FIG. 21 is a diagram illustrating an advantage example by the collection of the flow information. For example, a graph in FIG. 21 illustrates a collection result of the packet number between the core router CR1 and the core router CR2. A horizontal axis indicates the time period, and a vertical axis indicates the packet number. A term T1 is a term in which the flow information is collected in a state of fixing the sampling value with an initial value, and a term T2 is a term in which the flow information is collected by the sampling value corrected by the above-described processes. In the graph, a portion circled by a dashed line indicates a case of collecting the flow information with the sampling value fixed by the initial value. However, by collecting the flow information with a corrected sampling value, as indicated with a solid line, a further accurate result can be obtained.

As described above, according to the embodiment, the following advantages can be achieved.
(1) By dynamically conducting the correction control of the sampling value, since the sampling value is changed depending on a state (greater or smaller CPU use ratio) of each router, it is possible to capture packets by the proper sample number in a case of excessive increase of the CPU use ratio at the router. Accordingly, it is possible to acquire highly accurate flow information.
(2) Since the highly accurate flow information can be acquired, it is possible to utilize the acquired flow information for system maintenance and a facility design. For example, in a case of increasing a line bandwidth of a network router, it is possible to make the facility design match an appropriate traffic value, and to prevent excessive expansion.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A flow information collection apparatus, comprising:
a flow information accumulation part configured to periodically collect and accumulate flow information which is sampled based on a predetermined sampling value, from a router being a subject;
a distribution result calculation process part configured to specify a group of distributions of values for each measurement subject, from data in which the values for the each measurement subject in the flow information accumulated by said flow information accumulation part are distributed in a time period in a plurality of past days;
a distribution information determination process part configured to specify a representative group from the group specified by said distribution result calculation process part and to acquire an average; and
a correction information determination process part configured to determine the sampling value after a next time from the average of the representative group specified by said distribution information determination process part.

2. The flow information collection apparatus as claimed in claim 1, wherein the flow information accumulation part conducts sampling with a fixed sampling value for each router in a certain period from a collection start, and
said distribution result calculation process part, said distribution information determination process part, and said correction information determination process part start after the collection in the certain period.

3. The flow information collection apparatus as claimed in claim 1, further comprising:
an MIB information collection part configured to periodically collect and accumulate MIB information from the router;
an accumulation information calculation process part configured to calculate a CPU use rate of the router from the MIB information accumulated by said MIB information collection part; and
a measurement information conformity process part configured to determine whether or not a correction of the sampling value is valid in terms of the CPU use rate, a packet number, and a measurement delay time, and to cause the sampling value to conform to a further adequate value.

4. The flow information collection apparatus as claimed in claim 3, further comprising a special analysis process part configured to adjust the sampling value based on an outstanding value excluded from the group of the distributions, in which said measurement information conformity process part determines that the outstanding value does not conform.

5. The flow information collection apparatus as claimed in claim 4, further comprising a special diagnosis process part configured to be activated by said special analysis process part, determine validity of the outstanding value excluded from the group of the distributions based on system schedule information, and adjust the sampling value.

6. The flow information collection apparatus as claimed in claim 1, further comprising an accumulated information edit process part configured to extract information from the flow information accumulated by said flow information accumulation part and to accumulate basic data used for a process.

7. A flow information collection control method, comprising:
periodically collecting and accumulating flow information which is sampled based on a predetermined sampling value, from a router being a subject;
specifying a group of distributions of values for each measurement subject, from data in which the values for the each measurement subject in the flow information accumulated in said periodically collecting and accumulating flow information are distributed in a time period in a plurality of past days;
specifying a representative group from the group specified in said specifying a group of distributions and to acquire an average; and
determining the sampling value for next time from the average of the representative group specified in said specifying a representative group.

8. The flow information collection control method as claimed in claim 7, wherein said periodically collecting and accumulating flow information conducts sampling with a fixed sampling value for each router in a certain period from a collection start, and
said specifying a group of distributions, said specifying a representative group, and said determining the sampling value start after the collection in the certain period.

9. The flow information collection control method as claimed in claim 7, further comprising:
periodically collecting and accumulating MIB information from the router;
calculating a CPU use rate of the router from the MIB information accumulated in said periodically collecting and accumulating MIB information; and
determining whether or not a correction of the sampling value is valid in terms of the CPU use rate, a packet number, and a measurement delay time, and to cause the sampling value to conform to a further adequate value.

10. The flow information collection control method as claimed in claim 9, further comprising adjusting the sampling value based on an outstanding value excluded from the group of the distributions, in which it is determined by said determining validity of the correction that the outstanding value does not conformed.

11. The flow information collection control method as claimed in claim 10, further comprising determining validity of the outstanding value excluded from the group of the distributions based on system schedule information, and adjusting the sampling value, by being activated in said adjusting the sampling value.

12. The flow information collection control method as claimed in claim 7, further comprising extracting information from the flow information accumulated in said periodically collecting and accumulating the flow information and accumulating basic data used for a process.

13. A program product causing a computer to collect flow information, said program product comprising a computer-readable storage device encoded with a computer program that comprises the codes for:
periodically collecting and accumulating flow information which is sampled based on a predetermined sampling value, from a router being a subject;
specifying a group of distributions of values for each measurement subject, from data in which the values for the each measurement subject in the flow information accumulated in said periodically collecting and accumulating flow information are distributed in a time period in a plurality of past days;
specifying a representative group from the group specified in said specifying a group of distributions and to acquire an average; and
determining the sampling value for next time from the average of the representative group specified in said specifying a representative group.

14. The program product as claimed in claim 13, wherein said periodically collecting and accumulating flow information conducts sampling with a fixed sampling value for each router in a certain period from a collection start, and
said specifying a group of distributions, said specifying a representative group, and said determining the sampling value are conducted after the collection in the certain period.

15. The program product as claimed in claim 13, further comprising the codes for:
periodically collecting and accumulating MIB information from the router;
calculating a CPU use rate of the router from the MIB information accumulated in said periodically collecting and accumulating MIB information; and
determining whether or not a correction of the sampling value is valid in terms of the CPU use rate, a packet number, and a measurement delay time, and to cause the sampling value to conform to a further adequate value.

16. The program product as claimed in claim 15, further comprising the codes for adjusting the sampling value based on an outstanding value excluded from the group of the distributions, in which it is determined by said determining validity of the correction that the outstanding value does not conformed.

17. The program product as claimed in claim 16, further comprising the codes for determining validity of the outstanding value excluded from the group of the distributions based on system schedule information, and adjusting the sampling value, by being activated in said adjusting the sampling value.

18. The program product as claimed in claim 13, further comprising the codes for extracting information from the flow information accumulated in said periodically collecting and accumulating the flow information and accumulating basic data used for a process.
